(19) United States
(12) Patent Application Publication
(10) Pub. No.: US 2011/0229867 A1
(43) Pub. Date: Sep. 22, 2011

(54) SYSTEM AND METHOD OF ADMINISTRATING INSTRUCTIONS TO A RECIPIENT OF MEDICAL TREATMENT

(76) Inventors: Joseph William Gough, Whitmore Lake, MI (US); Michael David Roebuck, Ann Arbor, MI (US); James Edward Weber, Brighton, MI (US)

(21) Appl. No.: 13/053,177

(22) Filed: Mar. 21, 2011

Related U.S. Application Data
(60) Provisional application No. 61/315,804, filed on Mar. 19, 2010.

(51) Int. Cl. G09B 7/00

(52) U.S. Cl. 434/323

(57) ABSTRACT

A system and method of administrating instructions to a recipient of medical treatment are provided herein. For the method, a computer and an interface connected thereto are provided. Instructions are communicated to the recipient after medical treatment. At least one question is communicated to the recipient after communicating the instructions. An answer to the at least one question is inputted into the computer through the interface. The answer is compared to an acceptable answer stored in the computer. Feedback is provided to the recipient from the computer after comparing the answer to acceptable answer. The system includes the computer and interface connected thereto. The computer is programmed to perform the method steps. The system and method provided herein address the shortcomings of current practices regarding administration of instructions to recipients of medical treatment and may assist in minimizing readmittance due to failure of such recipients to follow discharge instructions.

### CROSS-REFERENCE TO RELATED APPLICATIONS

The subject patent application claims priority to, and all the benefits of, U.S. Provisional Patent Application Ser. No. 61/315,804 filed on Mar. 19, 2010. The entirety of this provisional patent application is expressly incorporated herein by reference.

### BACKGROUND OF THE INVENTION

1. Field of the Invention

The instant invention generally relates to a system and method of administrating instructions to an individual through a computer and interface connected thereto. More specifically, the instant invention relates to a system and method of administrating instructions to a recipient of medical treatment through a computer and interface connected thereto.

2. Description of the Related Art

One of the greatest financial issues facing health care facilities today is the uncompensated care that is given to recipients of medical treatment that are readmitted within thirty days of their discharge. Readmission can occur for various reasons, some preventable, some not.

A standard practice in place in the medical field is to provide discharge instructions to the recipients of medical treatment upon discharge. The delivery methods for discharge instructions include verbal explanations, written instructions, and/or video tutorials. The discharge instructions may include guidance on further at-home treatments, therapies, and/or medications that can be taken outside of the direct supervision of the provider of medical treatment. Recipients of medical treatment are typically required to sign a document attesting to an understanding of the discharge instructions, which addresses liability and malpractice concerns on the part of the provider of the medical treatment. The signed document generally disclaims the legal obligation of the provider of medical treatment in cases where the discharge instructions are not followed.

Readmittance of recipients of medical treatment can be attributable to a failure of the recipient of medical treatment to follow the discharge instructions. Failure of the recipient of medical treatment to follow the discharge instructions can be the result of complacency, administrative errors in administering the discharge instructions, or a lack of complete comprehension of the discharge instructions by the recipient of the medical treatment. Thus, while it may be the policy of the provider of medical treatment to systematically provide discharge instructions to recipients of medical treatment, and require attestation of receipt of the discharge instructions from the recipient of the medical treatment, it is challenging to ensure that the recipients of the medical treatment follow the discharge instructions after release from the care of the provider of the medical treatment. Even more, it is challenging to verify that the recipients of the medical treatment have actually read and/or understand the discharge instructions.

It is known to administer computerized questionnaires to new patients for entry of medical history. However, such practices do not address the issues associated with discharge instructions and, further, are incapable of assisting providers of medical treatment with preventing readmittance of the recipients of the medical treatment.

In view of the foregoing, there is a need to provide a system and method that addresses the shortcomings of current practices regarding administration of discharge instructions.

### SUMMARY OF THE INVENTION AND ADVANTAGES

The instant invention is directed to a system and method of administrating instructions to a recipient of medical treatment. For the method, a computer and an interface connected thereto are provided. Instructions are communicated to the recipient after medical treatment. At least one question is communicated to the recipient after communicating the instructions. An answer to the at least one question is inputted into the computer through the interface. The answer is compared to an acceptable answer stored in the computer. Feedback is provided to the recipient from the computer after comparing the answer to acceptable answer.

The system includes the computer and interface connected thereto. The computer is programmed to communicate instructions to the recipient after medical treatment, communicate at least one question to the recipient after communicating the instructions, compare the answer to an acceptable answer in the computer after an answer to the at least one question is inputted into the computer through the interface, and provide feedback to the recipient from the computer after comparing the answer to the acceptable answer.

The system and method of the instant invention address the shortcomings of current practices regarding administration of discharge instructions. In particular, by communicating questions regarding the discharge instructions, the likelihood of the recipient of medical treatment understanding the discharge instructions in increased over existing methods of merely presenting discharge instructions are requiring signature attesting to an understanding of the instructions. Further, by utilizing a computer with the answer to the at least one question inputted into the computer, there is an ability to track the answers from the recipient of medical treatment and monitor whether the recipient of the medical treatment comprehends the discharge instructions. In this regard, methodologies can be implemented to minimize readmittance due to failure of recipients of medical treatment to comprehend or completely read discharge instructions.

### DETAILED DESCRIPTION OF THE INVENTION

A system and method of administrating instructions to a recipient of medical treatment is provided herein. “Medical treatment”, as the term is used herein, refers to any type of treatment administered by a health care provider including, but not limited to, doctors, registered nurses, therapists, chiropractors, and dentists. Typically, the instructions are further defined as discharge instructions based upon the medical treatment administered to the recipient. In the immediately preceding context, the term “based” is meant to convey that there is a connection between the discharge instructions and the medical treatment administered. However, it is to be appreciated that the instructions may not necessarily be tied to discharge of the recipient of medical treatment. The discharge instructions may include guidance on further at-home treatments, therapies, and/or medications that can be taken outside of the direct supervision of the provider of medical treatment. However, it is to be appreciated that the instructions may include guidance for treatment, therapies, and/or medications to be followed while still under the care of a provider of medical treatment, such as during a hospital stay.

The method uses a computer and interface connected thereto. The computer generally refers to a processor and the computer with the interface connected thereto can be, for example, a personal computer, a laptop computer, a handheld computer, or a tablet computer. Alternatively, a terminal can be employed with the actual “computer” being located offsite and connected to the terminal through various communication channels such as, but not limited to, wireless connection, cable connection, and telephone line connection. Additionally, it is to be appreciated that multiple computers may be employed and the instant invention is not limited to use of a single computer to perform every step in the method of the instant invention. The computer is typically programmed to perform various steps in the method as described in further detail below.

The interface can be, but is not limited to, a computer monitor, television, and/or audio speaker in combination with a keyboard; a touch screen interface; and combinations thereof. The novelty and sophistication of the computer and interface may have an impact on the attention span, and thus comprehension, of the recipient of the medical treatment. For convenience and novelty (which may be a factor in engaging the recipient of medical treatment), the computer and interface connected thereto is preferably a tablet computer having a touch screen interface.

Typically, a storage medium is also connected to the computer. However, it is to be appreciated that the instant invention is not limited to use of a computer having a storage medium connected thereto. The storage medium can be any storage medium that is accessible to the computer and may be packaged along with the computer (such as in a laptop, handheld computer, or tablet computer), or may be located separately from the computer. For example, the storage medium can be a centralized record-storage medium utilized by a hospital and accessible to the computer through various communication channels such as, but not limited to, wireless connection, cable connection, and telephone line connection.

In accordance with the method described herein, in one embodiment, information for the recipient of medical treatment may be inputted into the storage medium connected to the computer. The information may be inputted for various purposes. In one embodiment, medical treatment information for the recipient of medical treatment is stored in the storage medium connected to the computer. Such medical treatment information may include, but is not limited to, information pertaining to the particular medical treatment that is currently administered to the recipient of medical treatment, medical history including comorbid conditions of the recipient, past medical treatment administered to the recipient, symptoms, vitals, and/or diagnostics. Alternatively, general identification information for the recipient of medical treatment may be inputted into the computer for purposes of correlating and tracking administration of instructions to the particular recipient of medical treatment. Of course, it is to be appreciated that the step of inputting information for the recipient is optional and that there may be alternative methodologies for correlating and tracking administration of instructions to the particular recipient of medical treatment.

The information for the recipient of medical treatment may be inputted into the storage medium through the computer 1) at a point of admission for the recipient of medical treatment into the care of the provider of medical treatment, 2) at the time of commencement of medical treatment, 3) during medical treatment, and/or 4) after medical treatment. It is to be appreciated that additional medical treatment information may be inputted into the storage medium at various times during medical treatment so as to keep a running record of the medical treatment.

In one embodiment, the medical treatment data for the recipient of medical treatment is collected and inputted into the storage medium and the computer is programmed to and determines likelihood of readmission based upon the medical treatment data. In the immediately preceding context, the term “based” is meant to convey that the computer is programmed to utilize the medical treatment data in the determination of the likelihood of readmission. The likelihood of readmission can be determined based upon comparison of the medical treatment data to archived data for related circumstances that have resulted in readmission of recipients of medical treatment in the past. The determination of likelihood of readmission may be employed in further steps performed by the computer, as described in detail below, such as for purposes of setting intensity of instruction and/or questioning, with a determined high risk of readmission correlated to more intensive instruction and/or questioning, and with a determined low chance of readmission correlated to less intensive instruction and/or questioning.

The instructions are communicated to the recipient after medical treatment. As set forth above, the instructions are typically discharge instructions but can alternatively be other instructions that are relevant to the medical treatment but that are not necessarily tied to discharge of the recipient of medical treatment. Typically, the instructions are communicated to the recipient from the computer through the interface. In this embodiment, the computer is programmed to communicate the instructions to the recipient after medical treatment. The instructions may be presented in a pre-templated electronic format. Further, the instructions may be communicated through an interactive environment of pre-recorded audio, video, and touch screen program utilizing the computer and interface(s) set forth above, which may maximize the level of comprehension of the recipient of medical treatment. The pre-recorded instructions may be multi-lingual in order to engage the recipient of medical treatment in their native language to further increase their comprehension and comfort. Live verbal engagement and information exchange with health care professionals and trained translators may also be provided as part of the instructions, but is not necessarily required. However, it is to be appreciated that the instructions can alternatively be communicated to the recipient of medical treatment, such as through simply providing a printed list of instructions, presenting a video containing the instructions, and/or providing audio instructions.

In the embodiment in which medical treatment information for the recipient of the medical treatment is inputted into the storage medium through the computer, the instructions communicated to the recipient of medical treatment may be generated by the computer based upon the medical treatment information. In this regard, the identification of appropriate discharge instructions can be effectively automated, thereby reducing human error in administration of instructions. Further, by retaining the medical treatment information for the recipient of the medical treatment, efficiencies in the process of correct identification and administration of discharge instructions can be achieved.

At least one question is communicated to the recipient of the medical treatment after communicating the instructions. Typically, a plurality of questions are communicated to the recipient of medical treatment. As with the instructions, the at least one question is typically communicated to the recipient from the computer through the interface. In this embodiment, the computer is programmed to communicate the at least one question to the recipient of the medical treatment after communication of the instructions (or by prompt of a user of the computer if the instructions are not communicated from the computer). However, it is to be appreciated that the questions can alternatively be communicated to the recipient of medical treatment, such as through providing a printed list of questions, presenting a video containing the questions, and/or providing audio questions.

In the embodiment in which medical treatment information for the recipient of the medical treatment is inputted into the storage medium through the computer, the at least one question communicated to the recipient of medical treatment may be generated by the computer based upon the medical treatment information. In this embodiment, the computer may be programmed to generate the at least one question. Such steps may be employed in conjunction with the above-described practice of determining the likelihood of readmission for purposes of setting intensity of instruction and/or questioning. For example, the at least one question, more typically a plurality or questions, may be generated by the computer based on the likelihood of readmission as determined by the computer. In the immediately preceding context, the term “based” is meant to convey that the computer is programmed to recognize particular details in the medical treatment information of the recipient of the medical treatment, and is further programmed to communicate a pre-determined set of questions to the recipient of medical treatment in response to recognizing the particular details. Alternatively, the medical treatment information can be used for the base purpose of identifying appropriate instructions and questions in response to the type of medical treatment administered.

Typically, the answer to the at least one question is contained in the instructions, with the at least one question communicated to the recipient of the medical treatment for the purpose of testing comprehension of the instructions. In the embodiment in which the plurality of questions are communicated to the recipient, communication of at least one further question may be delayed until an acceptable answer to a prior question is verified by the computer. The computer may be programmed to delay communication of the at least one further question in accordance with the step described immediately above. In this manner, overlapping question and answer patterns may be employed, with the patterns designed to outline some of the most important answers within the content of previous questions. For example, by delaying communication of a follow-up question until an acceptable answer to another related question is verified by the computer, important instructions can be reinforced within the recipient's memory.

An answer to the at least one question is inputted into the computer through the interface. Typically, the recipient of the medical treatment inputs the answer into the computer through the interface. However, it is to be appreciated that the recipient of the medical treatment may be assisted with inputting the answers into the computer so long as the answers originate with the recipient of the medical treatment.

The answer to the at least one question is compared an acceptable answer stored in the computer. Typically, the computer performs the comparison step and, in this regard, is programmed to do so. When the plurality of questions are employed, the answers may be compared to an acceptable answer immediately following entry of each answer. This step may be employed in the embodiment described above where communication of at least one further question is delayed until an acceptable answer to a prior question is verified. Alternatively, all answers may be compared to acceptable answers after the recipient of the medical treatment has inputted answers to all of the questions.

In one embodiment, a combination of data mining and web camera technology can be employed in a bio-surveillance capacity while the recipient of the medical treatment is answering the at least one question. This bio-surveillance can be used as another factor to determine the risk of patient readmission through recording of appearance and engagement, which may be reviewed by the provider of medical treatment or other parties. When appropriate, results can be shared with home health care providers and may allow care providers to take pre-emptive measures in further educating and monitoring at-risk recipients of medical treatment.

Based upon the format of the at least one question, comparison of the answer and the stored acceptable answer in the computer may require an exact match for the computer to verify the answers provided by the recipient of the medical treatment as acceptable. For example, if multiple choice is employed, an exact match may be required for the computer to verify that the provided answer matches an acceptable answer. Alternatively, if a fill-in-the-blank or short answer format is employed, the computer may be programmed to recognize key words or terms within the answer to verify that the provided answer matches an acceptable answer. The computer typically verifies the answer(s) as acceptable after conducting the comparison. However, it is to be appreciated that the computer may communicate results of the comparison to the provider of the medical treatment without rendering a determination as to whether the provided answer(s) match the acceptable answer(s).

Feedback is provided to the recipient from the computer after comparing the answer(s) to the acceptable answer(s). Under circumstances where the computer actually verifies whether the provided answer matches the stored acceptable answer, the computer may be programmed to provide feedback indicating the correctness or incorrectness of the provided answer. In this embodiment, the provided feedback may include re-communicating a question to which the answer does not match an acceptable answer for the question. Again, the re-communicated question may be provided immediately following an unacceptable answer or upon completion of all of the questions by the recipient of the medical treatment. Alternatively, the step of providing feedback may include communicating an acceptable answer to a question to the recipient of the medical treatment in response to an answer that does not match an acceptable answer for the question. Communication of the acceptable answer may occur after multiple instances of re-communicating incorrectly-answered questions.

In one embodiment, further instructions may be communicated to the recipient of medical treatment through the interface in response to an acceptable answer, and may further be communicated to the recipient of the medical treatment even in response to an unacceptable answer (although not preferred as the method of the subject invention seeks to obtain verification that the recipient of the medical treatment actually understands and comprehends the instructions). The further instruction may include a video and/or pictorial representation of the instruction at issue, and appropriate implementation of the instruction. Such a step may be helpful for purposes of reinforcing the understanding of the recipient of the medical treatment as to how to follow particular treatments, therapies, etc. in accordance with the instructions.

Under ideal circumstances, in one embodiment, the computer verifies all answers as acceptable and, after the computer verifies all answers as acceptable, provides feedback to the recipient including a notification of completion. In this circumstance, the recipient of the medical treatment may be provided with a release form acknowledging receipt of the instructions. The recipient of the medical treatment may be asked to sign or otherwise attest to understanding the instructions (such as by affirmatively checking a box or electrically signing if the release form is provided in electronic format). Upon execution, the release form may be inputted into the storage medium. A printout of the instructions may be generated for the recipient of the medical treatment. The recipient of the medical treatment could then be released with confidence that the recipient of the medical treatment adequately understands the discharge instructions.

The medical treatment information stored in the storage medium, including the answer(s) to the question(s) regarding the discharge instructions, may also be utilized for generating further communications to the recipient of the medical treatment after discharge. For example, the medical treatment information and answer(s) to the question(s) regarding the discharge instructions may be utilized to formulate follow-up strategies and further medical treatment reminders. Reminder emails and/or automated voice calls can be initiated to the recipient of the medical treatment after discharge. The reminder emails and/or calls can reiterate the instructions for ongoing care and check for progress. The emails and/or calls can be utilized to gather more information by asking questions and allowing the patient to make selections about their post-discharge health and behavior. Such practices can generate useful information in determining the readmission risks.

Unfortunately, the ideal circumstance may not be achieved and there may be circumstances in which there is a failure to verify that all answers as acceptable (typically performed by the computer). Such circumstances may arise due to complacency of the recipient of medical treatment, unwillingness of the recipient of medical treatment to completely answer the questions, or numerous other circumstances that could result in a failure of the recipient of medical treatment to completely answer the questions. Under such circumstances, an alert may be generated by the computer. The alert may be communicated to multiple parties and may be stored as part of the medical treatment information in the storage medium for the recipient of the medical treatment. The alert may be communicated to the provider of medical treatment, who may choose to take immediate action or conduct follow-up action. Further, the alert may be communicated to a third party, such as an insurance carrier. In this regard, potential medical malpractice issues and future health risks may be anticipated and tracked.

The system provided in accordance with the instant invention is substantially described above and includes the computer and interface connected thereto, with the computer programmed to perform the steps in the method as described above. In particular, the computer is programmed to communicate instructions to the recipient after medical treatment, communicate at least one question to the recipient after communicating the instructions, compare the answer to an acceptable answer in the computer after an answer to the at least one question is inputted into the computer through the interface, and provide feedback to the recipient from the computer after comparing the answer to the acceptable answer. As noted above, typically the feedback provided to the recipient from the computer includes a notification of completion after the computer verifies all answers as acceptable, with the computer being further programmed to generate an alert and communicate the alert to the provider of medical treatment in response to a failure of the computer to verify all answers as acceptable.

Obviously, many modifications and variations of the present invention are possible in light of the above teachings, and the invention may be practiced otherwise than as specifically described within the scope of the appended claims.

What is claimed is:

1. A method of administrating instructions to a recipient of medical treatment using a computer and interface connected thereto, said method comprising the steps of:
providing the computer and the interface connected thereto;
communicating instructions to the recipient after medical treatment;
communicating at least one question to the recipient after communicating the instructions;
inputting an answer to the at least one question into the computer through the interface;
comparing the answer to an acceptable answer stored in the computer; and
providing feedback to the recipient from the computer after comparing the answer to the acceptable answer.

2. A method as set forth in claim 1 wherein the instructions are further defined as discharge instructions based upon the medical treatment administered to the recipient.

3. A method as set forth in claim 1 wherein the step of providing feedback includes re-communicating a question to which the answer does not match an acceptable answer for the question.

4. A method as set forth in claim 1 wherein the step of providing feedback includes communicating an acceptable answer to a question to the recipient in response to an answer that does not match an acceptable answer for the question.

5. A method as set forth in claim 1 wherein the computer verifies all answers as acceptable and wherein feedback provided to the recipient from the computer includes a notification of completion after the computer verifies all answers as acceptable.

6. A method as set forth in claim 5 wherein the recipient is provided with a release form acknowledging receipt of the instructions.

7. A method as set forth in claim 5 wherein the computer fails to verify all answers as acceptable and wherein alert is generated by the computer.

8. A method as set forth in claim 7 wherein the alert is communicated to the provider of medical treatment.

9. A method as set forth in claim 1 wherein a plurality of questions are communicated to the recipient and wherein communication of at least one further question is delayed until an acceptable answer to a prior question is verified by the computer.

10. A method as set forth in claim 1 wherein the computer and interface connected thereto is further defined as a tablet computer having a touch screen interface.

11. A method as set forth in claim 1 wherein the instructions and the at least one question are communicated to the recipient from the computer through the interface.

12. A method as set forth in claim 1 wherein the answer to the at least one question is contained in the instructions.

13. A method as set forth in claim 1 further comprising the step of inputting information for the recipient of medical treatment in a storage medium connected to the computer.

14. A method as set forth in claim 13 wherein medical treatment information for the recipient of medical treatment is stored in the storage medium connected to the computer.

15. A method as set forth in claim 14 wherein the at least one question communicated to the recipient of medical treatment is generated by the computer based upon medical treatment information for the recipient of medical treatment.

16. A method as set forth in claim 13 wherein the information for the recipient of medical treatment is inputted into the storage medium through the computer at a point of admission for the recipient of medical treatment into the care of the provider of medical treatment.

17. A method as set forth in claim 16 wherein medical treatment data for the recipient of medical treatment is collected and inputted and wherein the computer determines likelihood of readmission based upon the medical treatment data.

18. A method as set forth in claim 17 wherein the at least one question is generated by the computer based on the likelihood of readmission as determined by the computer.

19. A system for administrating instructions to a recipient of medical treatment, said system comprising:
a computer and an interface connected thereto;
said computer programmed to:
communicate instructions to the recipient after medical treatment,
communicate at least one question to the recipient after communicating the instructions;
compare the answer to an acceptable answer in the computer after an answer to the at least one question is inputted into the computer through the interface; and
provide feedback to the recipient from the computer after comparing the answer to the acceptable answer.

20. A system as set forth in claim 19 wherein feedback provided to the recipient from the computer includes a notification of completion after the computer verifies all answers as acceptable, and wherein the computer is further programmed to generate an alert and communicate the alert to the provider of medical treatment in response to a failure of the computer to verify all answers as acceptable.
